(19) United States
(12) Patent Application Publication
(10) Pub. No.: US 2026/0285366 A1
(43) Pub. Date: Sep. 24, 2026

(54) PROCESSING APPARATUS AND PROCESSING METHOD

(71) Applicant: Robert Bosch GmbH, Stuttgart (DE)

(72) Inventors: Francois Guiot, Kanagawa (JP); Kevin Tomba, Kanagawa (JP); Yuya Matsumoto, Kanagawa (JP)

(21) Appl. No.: 19/140,190

(22) PCT Filed: Nov. 29, 2023
(86) PCT No.: PCT/IB2023/062006

§ 371 Date: Jun. 17, 2025

(30) Foreign Application Priority Data
Dec. 22, 2022 (JP) 2022-205038

(51) Int. Cl. B60W 60/00; B60W 50/14; G06V 20/56

(52) U.S. Cl. CPC B60W 60/0013; B60W 50/14; G06V 20/588; B60W 2552/53; B60W 2554/801; B60W 2556/40; B60W 2710/207

(57) ABSTRACT

A processing apparatus 18 is a processing apparatus that determines a target travel trajectory of a host vehicle 10, the processing apparatus including: an acquisition unit that acquires trajectory information indicating a standard travel trajectory, the standard travel trajectory being a travel trajectory that is generated based on information on a travel result of a plurality of vehicles and is typical in a traffic lane; and a determination unit that determines the target travel trajectory based on the trajectory information.

### BACKGROUND

The present invention relates to a processing apparatus and a processing method.

In recent years, automated driving technologies that enable a vehicle to travel automatically without driver's operation (specifically, acceleration and deceleration operation and steering operation) have been proposed. In automated driving, for example, a vehicle is controlled to follow a target travel trajectory as disclosed in WO2017/208781.

### SUMMARY

In a related art, for example, a target travel trajectory required for automated driving is determined to pass through the center of a traffic lane. However, when a vehicle travels along the target travel trajectory determined in this way, the wheel(s) of the vehicle may pass over an uneven portion (for example, a pothole, a manhole, or a bump) of a road surface, which may cause an impact on the vehicle and impair driving comfort.

The invention has been made in view of the above problem, and an object of the invention is to provide a processing apparatus and a processing method that can improve driving comfort.

In order to solve the above problem, the processing apparatus is a processing apparatus that determines a target travel trajectory of a host vehicle, the processing apparatus including: an acquisition unit acquiring trajectory information indicating a standard travel trajectory, the standard travel trajectory being a travel trajectory that is generated based on information on a travel result of a plurality of vehicles and is typical in a traffic lane; and a determination unit determining the target travel trajectory based on the trajectory information.

In order to solve the above problem, the processing method is a processing method for determining a target travel trajectory of a host vehicle, wherein an acquisition unit of a processing apparatus acquires trajectory information indicating a standard travel trajectory being a travel trajectory that is generated based on information on a travel result of a plurality of vehicles and is typical in a traffic lane, and a determination unit of the processing apparatus determines the target travel trajectory based on the trajectory information.

According to the invention, the driving comfort can be improved.

### BRIEF DESCRIPTION OF THE DRAWINGS

FIG. 1 is a schematic diagram illustrating a schematic configuration of a vehicle according to an embodiment of the invention.

FIG. 2 is a block diagram illustrating an example of a functional configuration of a processing apparatus according to the embodiment of the invention.

FIG. 3 is a block diagram illustrating an example of a functional configuration of a server according to the embodiment of the invention.

FIG. 4 is a flowchart illustrating an example of an entire processing flow performed by the processing apparatus according to the embodiment of the invention.

FIG. 5 is a diagram for explaining a target travel trajectory determined by the processing apparatus according to the embodiment of the invention.

FIG. 6 is a flowchart illustrating an example of a process of determining the target travel trajectory performed by the processing apparatus according to the embodiment of the invention.

FIG. 7 is a diagram for explaining a target travel trajectory determined with consideration of a lane boundary by the processing apparatus according to the embodiment of the invention.

### DETAILED DESCRIPTION

A preferred embodiment of the invention will be described in detail below with reference to the accompanying drawings. Dimensions, materials, other specific numerical values, and the like shown in the embodiment are only given as examples for facilitating understanding of the invention, and do not limit the invention unless otherwise specified. In the present specification and the drawings, components having substantially the same functions and configurations are denoted by the same reference signs to omit redundant descriptions, and components not directly related to the invention are not illustrated.

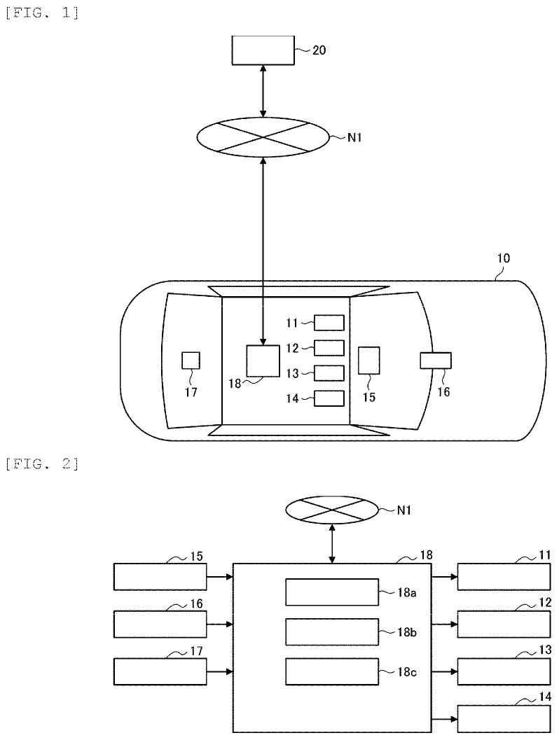

A configuration of a vehicle 10 according to an embodiment of the invention will be described with reference to FIGS. 1 to 3.

FIG. 1 is a schematic diagram illustrating a schematic configuration of the vehicle 10. As illustrated in FIG. 1, the vehicle 10 can communicate wirelessly with a server 20 via a wireless communication network N1. A processing apparatus 18 (to be described below) provided to the vehicle 10 performs processing using information collected by the server 20, thereby performing automated driving of the vehicle 10. Note that, FIG. 1 illustrates one vehicle 10 for ease of understanding, but actually, a plurality of vehicles 10 are communicable with the server 20 via the communication network N1. In the following description, the vehicle 10 to be controlled by the processing apparatus 18 is specifically referred to as a host vehicle 10.

As illustrated in FIG. 1, the vehicle 10 includes a drive source 11, a brake apparatus 12, a steering mechanism 13, a display apparatus 14, a navigation apparatus 15, a surrounding environment sensor 16, a vehicle speed sensor 17, and the processing apparatus 18.

The drive source 11 outputs drive power to be transmitted to a drive wheel of the vehicle 10. Examples of the drive source 11 include an engine or an electric motor.

The brake apparatus 12 applies a braking force to a wheel of the vehicle 10. For example, the brake apparatus 12 includes a hydraulic pressure control unit, and the hydraulic pressure control unit regulates the hydraulic pressure of a brake oil of a wheel cylinder, thereby regulating the braking force applied to the wheel.

The steering mechanism 13 is a mechanism for changing a tire steering angle of the vehicle 10. For example, the steering mechanism 13 is connected to a steering wheel and changes the tire steering angle in response to steering operation by a driver using the steering wheel.

The display apparatus 14 is a device that visually displays various types of information. Examples of the display apparatus 14 include a liquid-crystal display or a lamp.

The navigation apparatus 15 provides route guidance from a current location of the vehicle 10 to a destination desired by the driver. The navigation apparatus 15 displays various types of information related to the route guidance (for example, a current location of the vehicle 10, a travel route on which the guidance is provided, a location of a destination, a distance on the travel route from the current location of the vehicle 10 to the destination, and an arrival time at the destination). The navigation apparatus 15 can acquire position information of the vehicle 10 based on information transmitted from Global Positioning System (GPS) satellites.

The surrounding environment sensor 16 detects surrounding environment information related to the environment surrounding the vehicle 10. For example, the surrounding environment sensor 16 is provided to a front part of the vehicle 10 and detects the surrounding environment information in front of the vehicle 10. The surrounding environment information detected by the surrounding environment sensor 16 may be information related to a distance to or a direction of a detection object located around the vehicle 10 (for example, a relative position, a relative distance, a relative speed, or a relative acceleration), or may be a feature of a detection object located around the vehicle 10 (for example, a type of the detection object, a shape of the detection object, or a mark attached to the detection object). The surrounding environment sensor 16 is, for example, a radar, a Lidar sensor, an ultrasonic sensor, or a camera.

The vehicle speed sensor 17 detects a vehicle speed which is the speed of the vehicle 10. The processing apparatus 18 includes a central processing unit (CPU) which is an arithmetic processing unit, a read-only memory (ROM) which is a memory element storing programs and arithmetic parameters used by the CPU, and a random access memory (RAM) which is a memory element temporarily storing parameters that change appropriately in the execution of the CPU. For example, one processing apparatus 18 may be provided, or a plurality of processing apparatuses 18 may be provided.

FIG. 2 is a block diagram illustrating an example of a functional configuration of the processing apparatus 18. As illustrated in FIG. 2, the processing apparatus 18 includes, for example, a communication unit 18a, a determination unit 18b, and a control unit 18c. The processing apparatus 18 can acquire information from the navigation apparatus 15, the surrounding environment sensor 16, and the vehicle speed sensor 17, and can output a control command to the drive source 11, the brake apparatus 12, the steering mechanism 13, and the display apparatus 14. Note that, in this specification, acquisition of information includes extraction, generation, or the like of information.

The communication unit 18a communicates with the server 20 via the communication network N1. For example, when the communication unit 18a sends a request for transmission of desired information to the server 20, the desired information is transmitted from the server 20 so that the communication unit 18a can receive the desired information. The communication unit 18a is an example of the acquisition unit according to the invention.

The determination unit 18b determines a target travel trajectory of the host vehicle 10. The vehicle 10 can perform automated driving in which the host vehicle 10 is caused to travel automatically without driver's operation (specifically, acceleration and deceleration operation and steering operation). The target travel trajectory is a target trajectory along which the host vehicle 10 is caused to travel by the automated driving.

The control unit 18c controls the drive source 11, the brake apparatus 12, the steering mechanism 13, and the display apparatus 14. For example, the control unit 18c can perform the automated driving by controlling the drive source 11, the brake apparatus 12, and the steering mechanism 13. In the automated driving, the control unit 18c controls the host vehicle 10 such that the host vehicle 10 travels along the target travel trajectory without operation by a driver of the host vehicle 10. For example, in the vehicle 10, the driver can choose whether to perform the automated driving. In addition, for example, the control unit 18c can make various kinds of notifications by controlling the display apparatus 14.

The server 20 in FIG. 1 collects and manages information from the plurality of vehicles 10 and transmits information to be used for processing by the processing apparatus 18 to the processing apparatus 18. For example, a part or whole of the server 20 includes a microcomputer or a microprocessor unit. In addition, for example, a part or whole of the server 20 may include an updatable element such as firmware, or may include a program module or the like that is executed in accordance with a command from a CPU or the like. For example, one server 20 may be provided, or a plurality of servers 20 may be provided.

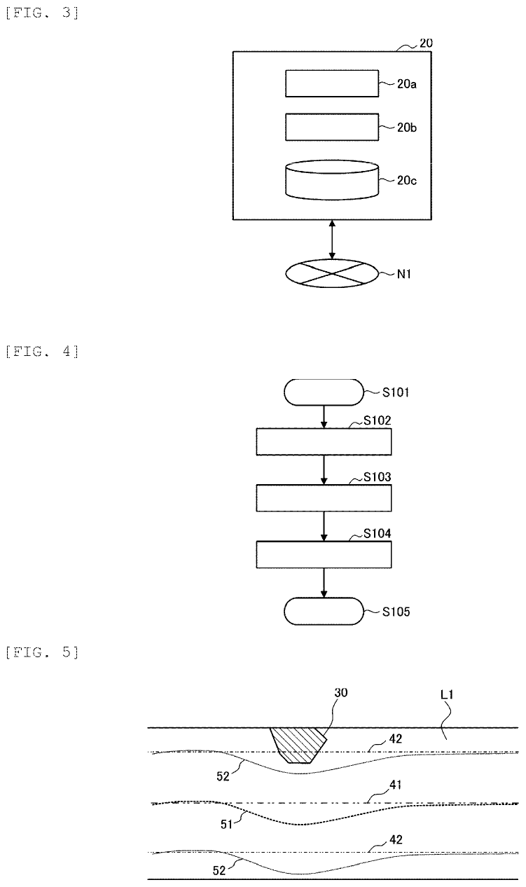

FIG. 3 is a block diagram illustrating an example of a functional configuration of the server 20. As illustrated in FIG. 3, the server 20 includes, for example, a communication unit 20a, a processing unit 20b, and a storage unit 20c.

The communication unit 20a communicates with each of the plurality of vehicles 10 via the communication network N1.

The processing unit 20b performs various types of statistical processing on information acquired by the server 20. For example, the processing unit 20b performs statistical processing on information stored in the storage unit 20c, thereby generating new information. Note that the processing unit 20b may perform statistical processing on information received by the communication unit 20a, and store information generated thereby in the storage unit 20c.

The storage unit 20c stores various types of information. For example, the storage unit 20c stores information received by the communication unit 20a and information generated by the statistical processing by the processing unit 20b. Specifically, the storage unit 20c stores a dataset containing various types of information generated based on information related to a travel result of the plurality of vehicles 10. The travel result described above is the result related to the actual driving of each vehicle 10 (for example, a result indicating a position and a speed at which the vehicle has traveled). The types of the plurality of vehicles 10 described above may include various types such as a passenger car and a truck.

Here, datasets stored in the server 20 contain, as the information generated based on the information related to the travel result of the plurality of vehicles 10, trajectory information indicating a standard travel trajectory that is a travel trajectory typical in a traffic lane. In the present embodiment, the trajectory information is utilized by the processing apparatus 18, whereby the driving comfort is improved.

The standard travel trajectory is a travel trajectory that is typical with respect to the travel trajectories of the respective vehicles 10 when the plurality of vehicles 10 actually travel. Note that the travel trajectory means, for example, a trajectory through which the center of the vehicle 10 passes. For example, the standard travel trajectory is set in association with map data in a dataset. The standard travel trajectory is generated, for example, by merging (for example, averaging) travel trajectories of the respective vehicles 10 when the plurality of vehicles 10 actually travel. However, the standard travel trajectory is not limited to a trajectory obtained by averaging a plurality of actual travel trajectories, but may be, for example, a trajectory that passes through the center of the plurality of actual travel trajectories in a traffic lane width direction. Information indicating a travel trajectory in a traffic lane when each vehicle 10 actually travels is generated by the server 20, for example, by using various types of information transmitted from each vehicle 10 to the server 20 (for example, position information acquired by the navigation apparatus 15 and surrounding environment information detected by the surrounding environment sensor 16).

The datasets stored in the server 20 may contain, as the information generated based on the information related to the travel result of the plurality of vehicles 10, various types of information other than the trajectory information. For example, a dataset may contain vehicle speed information indicating a standard vehicle speed that is a vehicle speed typical for each traffic lane. The standard vehicle speed is generated, for example, by merging (for example, averaging) vehicle speeds of the respective vehicles 10 for each traffic lane when the plurality of vehicles 10 actually travel. In addition, for example, a dataset may contain information obtained by merging respective information related to a gradient, a legal speed, presence or absence of an accident, road surface conditions, or the like at each travel position when the plurality of vehicles 10 actually travel. Further, for example, a dataset may contain information obtained by merging detection points indicating traffic lane boundaries detected by the surrounding environment sensor 16 of each vehicle 10 when the plurality of vehicles 10 actually travel. In a dataset, for example, the various types of information described above are incorporated into map data.

The datasets stored in the server 20 may be prepared separately for each time of day, each day of week, each month, or each season. For example, a dataset generated from information acquired during daytime and a dataset generated from information acquired during night-time may be prepared separately. In that case, the processing apparatus 18 of the vehicle 10 can acquire the information contained in the dataset corresponding to the current time of day.

The datasets stored in the server 20 may be prepared separately for each area divided on a map. In that case, the processing apparatus 18 of the vehicle 10 can acquire information contained in a dataset of an area corresponding to a current travel position of the vehicle 10.

The datasets may be updated at intervals of one day, or may be updated at intervals of time longer than one day, or may be updated at intervals of time shorter than one day. For example, when the datasets are updated at intervals of one hour, the processing apparatus 18 of the vehicle 10 may acquire the latest dataset.

Operation of the processing apparatus 18 according to the embodiment of the invention will be described with reference to FIGS. 4 to 7.

FIG. 4 is a flowchart illustrating an example of an entire processing flow performed by the processing apparatus 18. Step S101 in FIG. 4 corresponds to the start of a control flow illustrated in FIG. 4. Step S105 in FIG. 4 corresponds to the end of the control flow illustrated in FIG. 4. The control flow illustrated in FIG. 4 is repeatedly performed, for example, at preset time intervals.

After the control flow illustrated in FIG. 4 is started, in step S102, the communication unit 18a acquires the trajectory information from the server 20. As described above, the trajectory information is information indicating the standard travel trajectory that is a travel trajectory typical in a traffic lane and is generated based on the information related to the travel result of the plurality of vehicles 10.

For example, the communication unit 18a acquires, from the server 20, the trajectory information indicating the standard travel trajectory of the host vehicle 10 in a travel lane. More specifically, the communication unit 18a acquires, among such trajectory information, the trajectory information contained in a dataset corresponding to an area including the current traveling position of the host vehicle 10 from the server 20.

Following step S102, in step S103, the determination unit 18b determines a target travel trajectory. Here, the determination unit 18b determines the target travel trajectory based on the trajectory information acquired in step S102. As will be described below, when the automated driving is performed, the host vehicle 10 is controlled to travel along the target travel trajectory.

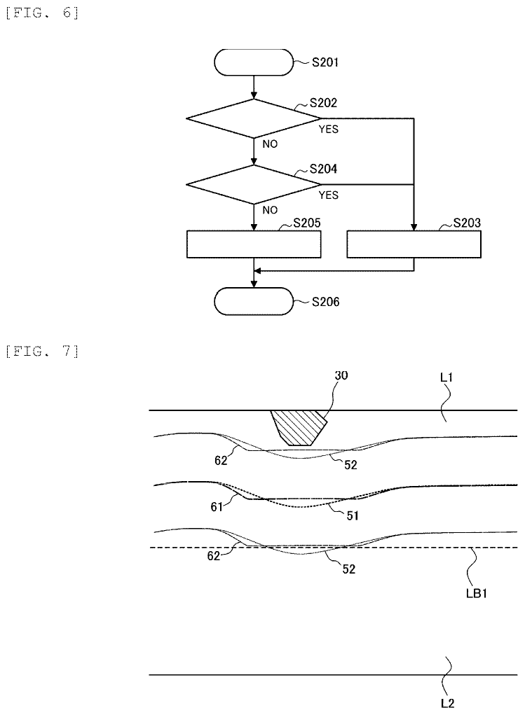

FIG. 5 is a diagram for explaining a target travel trajectory determined by the processing apparatus 18. In the example of FIG. 5, the road surface of a travel lane L1 of the host vehicle 10 includes an uneven portion 30 at an end in a lane width direction. The uneven portion 30 is, for example, a pothole, a manhole, or a bump. In the example of FIG. 5, a travel trajectory 41 is a trajectory determined as a target travel trajectory in a comparative example, and a travel trajectory 51 is a trajectory determined as a target travel trajectory in the present embodiment.

In the comparative example, for example, the travel trajectory 41 passing through the center of the travel lane L1 is determined as a target travel trajectory. As illustrated in FIG. 5, when the host vehicle 10 travels along the target travel trajectory (i.e., the travel trajectory 41) determined in this way, a part of a trajectory 42 of a wheel passes over the unevenness 30. Thus, when the wheel passes over the uneven portion 30, the host vehicle 10 may be subject to impact and the driving comfort may be impaired.

On the other hand, in the present embodiment, the determination unit 18b determines, for example, the travel trajectory 51 that follows the standard travel trajectory as a target travel trajectory. In the example of FIG. 5, the travel trajectory 51 is a trajectory coincident with the standard travel trajectory. However, the travel trajectory 51 that follows the standard travel trajectory may include a trajectory portion (for example, a trajectory portion obtained by offsetting the standard travel trajectory in the lane width direction) other than trajectory portions that coincide with the standard travel trajectory. The plurality of vehicles 10 has actually traveled in the travel lane L1 so as to avoid the uneven portion 30. Thus, as illustrated in FIG. 5, when the host vehicle 10 travels along the standard travel trajectory (the travel trajectory 51 in FIG. 5) generated based on the information related to the travel result of the plurality of vehicles 10, the uneven portion 30 does not exist at a trajectory 52 of a wheel. Accordingly, since it is possible to prevent the wheel from passing over the uneven portion 30 and thus the host vehicle 10 from being subject to impact, the driving comfort can be improved.

The surrounding environment sensor 16 is an example of a sensor that detects road surface information. The road surface information includes various types of information related to the conditions of a road surface, and, for example, may include information indicating whether an obstacle such as the uneven portion 30 exists at the road surface, or information indicating a position of an obstacle such as the uneven portion 30 in the travel lane L1. In the present specification, although the uneven portion 30 is mainly described as an example of an obstacle on a road surface, examples of the obstacle include various obstacles such as a fallen object including a fallen rock, a puddle, a disabled vehicle, and a groove on a road shoulder. The communication unit 18a acquires information indicating the position of the uneven portion 30 in the travel lane L1 based on the detection result of the surrounding environment sensor 16. Then, based on the information indicating the position of the uneven portion 30 in the travel lane L1 acquired from the surrounding environment sensor 16, the determination unit 18b can also determine a travel trajectory in which the wheel does not pass over the uneven portion 30 as a target travel trajectory. However, when it is difficult for the surrounding environment sensor 16 to detect the uneven portion 30 due to the influence of rain or the like, it is also difficult to determine a target travel trajectory based on the detection result of the surrounding environment sensor 16. On the other hand, the determination unit 18b determines a target travel trajectory based on the trajectory information acquired from the server 20, and thus the target travel trajectory can be determined regardless of the influence of rain or the like.

Following step S103 in FIG. 4, in step S104, the control unit 18c performs automated driving based on the target travel trajectory determined in step S103, and the control flow illustrated in FIG. 4 is ended.

Specifically, in the automated driving, the control unit 18c controls the host vehicle 10 such that the host vehicle 10 travels along the target travel trajectory without operation by a driver of the host vehicle 10. More specifically, the control unit 18c determines a target tire steering angle such that the host vehicle 10 can travel the target travel trajectory, and controls the steering mechanism 13 so as to make a tire steering angle to be coincident with the target tire steering angle. Accordingly, the host vehicle 10 is appropriately controlled to travel along the target travel trajectory.

The control unit 18c can control the speed of the host vehicle 10 by controlling the drive source 11 and the brake apparatus 12 during the automated driving. For example, the control unit 18c determines a target vehicle speed, and controls the drive source 11 and the brake apparatus 12 based on a difference between the target vehicle speed and a vehicle speed acquired from the vehicle speed sensor 17. As a result, the vehicle speed of the host vehicle 10 can be controlled to be coincident with the target vehicle speed. The target vehicle speed can be determined by various methods. For example, the target vehicle speed may be set by a driver, may be determined with consideration of a positional relationship between the host vehicle 10 and a vehicle ahead, may be determined with consideration of a target tire steering angle, or may be determined with consideration of a standard vehicle speed which is a typical vehicle speed for each lane.

Here, the determination unit 18b may determine, as a target travel trajectory, a travel trajectory other than a travel trajectory that strictly follows the standard travel trajectory. For example, the determination unit 18b may determine, as a target travel trajectory, a trajectory that follows the standard travel trajectory as a whole but partially deviates from the standard travel trajectory. Such a travel trajectory may also be included in a travel trajectory that follows the standard travel trajectory.

For example, there may be an adjacent lane (see an adjacent lane L2 in FIG. 7 to be described below) adjacent to the travel lane L1 of the host vehicle 10. In that case, it may be necessary to ensure that the host vehicle 10 does not go beyond a lane boundary (see a lane boundary LB1 in FIG. 7 to be described below) between the travel lane L1 and the adjacent lane. Therefore, the determination unit 18b may determine, as a target travel trajectory, a travel trajectory obtained by correcting a travel trajectory that strictly follows the standard travel trajectory with consideration of the lane boundary. Hereinafter, an example in which a target travel trajectory is determined with consideration of a lane boundary will be described with reference to FIGS. 6 and 7.

FIG. 6 is a flowchart illustrating an example of a determination process of a target travel trajectory performed by the processing apparatus 18. The control flow illustrated in FIG. 6 corresponds to an example of the processing performed in step S103 of FIG. 4. Step S201 in FIG. 6 corresponds to the start of the control flow illustrated in FIG. 6. Step S206 in FIG. 6 corresponds to the end of the control flow illustrated in FIG. 6.

The control flow illustrated in FIG. 6 will be described below by referring to FIG. 7 as appropriate. FIG. 7 is a diagram for explaining a target travel trajectory determined by the processing apparatus 18 with consideration of the lane boundary LB1. In the example in FIG. 7, the adjacent lane L2 is adjacent to the travel lane L1 of the host vehicle 10 across the lane boundary LB1. The travel direction in the travel lane L1 and the travel direction in the adjacent lane L2 may coincide with each other, or may oppose to each other. That is, the adjacent lane L2 may be a travel lane or a passing lane for traveling in the same direction as the travel lane L1 in which the host vehicle 10 travels, or may be an opposing lane for traveling in the opposite direction to the travel lane L1.

After the start of the control flow illustrated in FIG. 6, in step S202, the determination unit 18b determines whether a possibility of collision between the host vehicle 10 and another vehicle traveling in the adjacent lane L2 exceeds a criterion.

Specifically, the possibility of collision in step S202 means a possibility of collision between the host vehicle 10 and another vehicle traveling in the adjacent lane L2 if the host vehicle 10 goes beyond the lane boundary LB1. Therefore, a case where it is determined that there is a possibility that the host vehicle 10 collides with another vehicle traveling in the adjacent lane L2 if the host vehicle 10 goes beyond the lane boundary LB1 corresponds to a case where the possibility of collision exceeds the criterion.

For example, the determination unit 18b determines the possibility of collision based on positional relationship information that is information about the positional relationship between the host vehicle 10 and another vehicle traveling in the adjacent lane L2. The positional relationship information described above may contain, for example, information about a relative position, a relative distance, a relative speed, a relative acceleration, a relative jerk, or a passing time difference of the host vehicle 10 with respect to the another vehicle. However, the positional relationship information may be information of other physical quantities that can be practically converted to these information. The positional relationship information can be acquired, for example, based on surrounding environment information obtained from the surrounding environment sensor 16 or the like.

When it is determined that the possibility of collision between the host vehicle 10 and another vehicle traveling in the adjacent lane L2 exceeds the criterion (step S202/YES), the processing proceeds to step S203. On the other hand, when it is determined that the possibility of collision between the host vehicle 10 and another vehicle traveling in the adjacent lane L2 is lower than the criterion (step S202/NO), the processing proceeds to step S204.

When “YES” is determined in step S202, in step S203, the determination unit 18b determines a target travel trajectory with consideration of the lane boundary LB1, and the control flow illustrated in FIG. 6 is ended. Here, the determination unit 18b determines the target travel trajectory based on a positional relationship between the lane boundary LB1 and the standard travel trajectory. The positional relationship between the lane boundary LB1 and the standard travel trajectory can be determined, for example, based on a recognition result of the lane boundary LB1 by the surrounding environment sensor 16 (recognition result of a relative position of the lane boundary LB1 with respect to the host vehicle 10, or the like) and the trajectory information acquired from the server 20.

In the example of FIG. 7, the travel trajectory 51 is a travel trajectory that is determined as a target travel trajectory when the target travel trajectory is determined without consideration of the lane boundary LB1 (that is, when the target travel trajectory is determined not based on the positional relationship between the lane boundary LB1 and the standard travel trajectory). On the other hand, a travel trajectory 61 is a travel trajectory that is determined as a target travel trajectory when the target travel trajectory is determined with consideration of the lane boundary LB1 (that is, when the target travel trajectory is determined based on the positional relationship between the lane boundary LB1 and the standard travel trajectory).

When determining a target travel trajectory without consideration of the lane boundary LB1, the determination unit 18b determines, for example, the travel trajectory 51 that strictly follows the standard travel trajectory as the target travel trajectory. Similar to the example of FIG. 5 described above, the travel trajectory 51 is a trajectory coincident with the standard travel trajectory. As illustrated in FIG. 7, a part of the trajectory 52 of a wheel may go beyond the lane boundary LB1 when the host vehicle 10 travels along the target travel trajectory (i.e., the travel trajectory 51) determined in this way. That is, the host vehicle 10 may go beyond the lane boundary LB1.

On the other hand, when determining a target travel trajectory with consideration of the lane boundary LB1, the determination unit 18b determines, for example, the target travel trajectory such that the host vehicle 10 does not go beyond the lane boundary LB1 when the host vehicle 10 travels along the target travel trajectory. In the example of FIG. 7, the determination unit 18b determines, as the target travel trajectory, the travel trajectory 61 obtained by correcting the travel trajectory 51 that strictly follows the standard travel trajectory. As illustrated in FIG. 7, when the host vehicle 10 travels along the target travel trajectory (i.e., the travel trajectory 61) determined in this way, a trajectory 62 of a wheel does not go beyond the lane boundary LB1. That is, the host vehicle 10 does not go beyond the lane boundary LB1 when traveling along the travel trajectory 61. Accordingly, the host vehicle 10 can be prevented from colliding with another vehicle traveling in the adjacent lane L2.

Note that, when determining a target travel trajectory with consideration of the lane boundary LB1, the determination unit 18b may determine the target travel trajectory so as to permit the host vehicle 10 to slightly go beyond the lane boundary LB1 when the host vehicle 10 travels along the target travel trajectory.

When “NO” is determined in step S202 in FIG. 6, in step S204, the determination unit 18b determines whether there is an obstacle at the lane boundary LB1. Examples of the obstacle present at the lane boundary LB1 include a center divider or a pole that separates between the travel lane L1 and the adjacent lane L2. Information indicating whether there is an obstacle at the lane boundary LB1 can be acquired, for example, based on surrounding environment information obtained from the surrounding environment sensor 16 or the like.

When it is determined that there is an obstacle at the lane boundary LB1 (step S204/YES), the processing proceeds to step S203. On the other hand, when it is determined that there is no obstacle at the lane boundary LB1 (step S204/NO), the processing proceeds to step S205.

When “YES” is determined in step S204, in step S203, the determination unit 18b determines a target travel trajectory with consideration of the lane boundary LB1, and the control flow illustrated in FIG. 6 is ended. In this way, the determination unit 18b determines a target travel trajectory with consideration of the lane boundary LB1 not only when it is determined that the possibility of collision between the host vehicle 10 and another vehicle traveling in the adjacent lane L2 exceeds the criterion, but also when it is determined that there is an obstacle at the lane boundary LB1. Accordingly, the host vehicle 10 can be prevented from going beyond the lane boundary LB1 and colliding with an obstacle present at the lane boundary LB1.

On the other hand, when “NO” is determined in step S204, in step S205, the determination unit 18b determines a target travel trajectory without consideration of the lane boundary LB1. In this case, in the example of FIG. 7, the determination unit 18b determines, for example, the travel trajectory 51 as the target travel trajectory.

An example of the processing performed by the processing apparatus 18 has been described above with reference to FIGS. 4 to 6. However, the processing performed by the processing apparatus 18 is not limited to the above-described example, and may be, for example, processing obtained by appropriately modifying the above-described example.

For example, in the control flow in FIG. 6, step S202 may be omitted, or step S204 may be omitted. Alternatively, both step S202 and step S204 may be omitted, and the determination unit 18b may determine a target travel trajectory with consideration of the lane boundary LB1 when the surrounding environment sensor 16 can recognize the lane boundary LB1, or may determine a target travel trajectory without consideration of the lane boundary LB1 when the surrounding environment sensor 16 cannot recognize the lane boundary LB1.

In addition, for example, the determination unit 18b may determine a target travel trajectory based on the trajectory information as well as the detection result of the surrounding environment sensor 16. As described above, the surrounding environment sensor 16 is an example of a sensor that detects road surface information. For example, when the uneven portion 30 is detected by the surrounding environment sensor 16, the determination unit 18b may determine a target travel trajectory based on the information indicating the position of the uneven portion 30 in the travel lane L1 acquired from the surrounding environment sensor 16. On the other hand, when the uneven portion 30 is not detected by the surrounding environment sensor 16, the determination unit 18b may determine a target travel trajectory based on the trajectory information acquired from the server 20. In this way, when a target travel trajectory is determined by using the trajectory information together with the detection result of the surrounding environment sensor 16, and when the uneven portion 30 is detected by the surrounding environment sensor 16, the target travel trajectory can be determined using accurate information about the uneven portion 30 acquired from the surrounding environment sensor 16. Therefore, the target travel trajectory can be determined appropriately even when it is difficult for the surrounding environment sensor 16 to detect the uneven portion 30 due to the influence of rain or the like.

In the example of the processing in FIG. 4 above, the target travel trajectory is used for automated driving. However, a target travel trajectory may be used for applications other than automated driving. For example, the control unit 18c may perform notification control for notifying a driver of the host vehicle 10 of a target travel trajectory. In the notification control, the control unit 18c may notify the driver of a target travel trajectory, for example, by displaying the target travel trajectory on the display apparatus 14. However, a notification of a target travel trajectory is not limited to an example in which the notification is performed using the display apparatus 14. For example, the notification of a target travel trajectory may be performed using a display apparatus (for example, a smartphone or a tablet terminal) that is not mounted on the vehicle 10 but owned by a passenger of the vehicle 10. Alternatively, for example, the notification of a target travel trajectory may be performed by sound in addition to display.

Effects of the processing apparatus 18 according to the embodiment of the invention will be described.

The processing apparatus 18 includes an acquisition unit (the communication unit 18a in the above example) that acquires trajectory information indicating a standard travel trajectory being a travel trajectory that is generated based on information on a travel result of a plurality of vehicles and is typical in a traffic lane, and the determination unit 18b that determines a target travel trajectory based on the trajectory information. Accordingly, when the host vehicle 10 travels along the target travel trajectory, it is possible to prevent a wheel of the host vehicle 10 from passing over the uneven portion 30 and the host vehicle 10 from being subject to impact, whereby the driving comfort can be improved. Further, as compared to a case where a target travel trajectory is determined based on the detection result of the surrounding environment sensor 16, it is possible to determine a target travel trajectory without being affected by rain or the like.

Preferably, in the processing apparatus 18, the determination unit 18b determines a travel trajectory (the travel trajectory 51 or 61 in the above example) that follows the standard travel trajectory as a target travel trajectory. Accordingly, when the host vehicle 10 travels along the target travel trajectory, a wheel of the host vehicle 10 is appropriately prevented from passing over the uneven portion 30 and thus the host vehicle 10 is appropriately prevented from being subject to impact, whereby the driving comfort can be appropriately improved.

Preferably, in the processing apparatus 18, the determination unit 18b determines a target travel trajectory based on a positional relationship between the lane boundary LB1, which is a boundary between the travel lane L1 of the host vehicle 10 and the adjacent lane L2 adjacent to the travel lane L1, and the standard travel trajectory. Accordingly, when the host vehicle 10 travels along the target travel trajectory, it is possible to prevent the host vehicle 10 from going beyond the lane boundary LB1 or make the host vehicle 10 unlikely to go beyond the lane boundary LB1. Thus, the host vehicle 10 can be prevented from colliding with another vehicle or an obstacle.

Preferably, in the processing apparatus 18, the determination unit 18b determines a target travel trajectory such that the host vehicle 10 does not go beyond the lane boundary LB1 when the host vehicle 10 travels along the target travel trajectory. Accordingly, when the host vehicle 10 travels along the target travel trajectory, the host vehicle 10 can be appropriately prevented from going beyond the lane boundary LB1. Thus, the host vehicle 10 is appropriately prevented from colliding with another vehicle or an obstacle.

Preferably, in the processing unit 18, the determination unit 18b determines a target travel trajectory based on the positional relationship between the lane boundary LB1 and the standard travel trajectory when a possibility of collision between the host vehicle 10 and another vehicle traveling in the adjacent lane L2 exceeds a criterion, and determines a target travel trajectory not based on the positional relationship between the lane boundary LB1 and the standard travel trajectory when the possibility of collision is lower than the criterion. Accordingly, while the host vehicle 10 can be prevented from colliding with another vehicle when the possibility of collision exceeds the criterion, a wheel of the host vehicle 10 can be more appropriately prevented from passing over the uneven portion 30 and the host vehicle 10 can be more appropriately prevented from being subject to impact when the possibility of collision is lower than the criterion.

Preferably, in the processing unit 18, the determination unit 18b determines a target travel trajectory based on the positional relationship between the lane boundary LB1 and the standard travel trajectory when it is determined that an obstacle is present at the lane boundary LB1, and determines a target travel trajectory not based on the positional relationship between the lane boundary LB1 and the standard travel trajectory when it is determined that no obstacle is present at the lane boundary LB1. Accordingly, when there is an obstacle at the lane boundary LB1, the host vehicle 10 can be prevented from colliding with the obstacle. On the other hands, when there is no obstacle at the lane boundary LB1, a wheel of the host vehicle 10 can be more appropriately prevented from passing over the uneven portion 30 and the host vehicle 10 can be more appropriately prevented from being subject to impact.

Preferably, in the processing apparatus 18, a sensor that detects road surface information (the surrounding environment sensor 16 in the above example) is mounted to the host vehicle 10, and the determination unit 18b determines a target travel trajectory based on the detection result of the sensor in addition to the trajectory information. Accordingly, since the target travel trajectory is determined by using the trajectory information together with the detection result of the above-described sensor, when the sensor detects the uneven portion 30, the target travel trajectory can be determined using accurate information about the uneven portion 30 acquired from the sensor. Further, the target travel trajectory can be determined appropriately even when it is difficult for the sensor to detect the uneven portion 30 due to the influence of rain or the like.

Preferably, the processing apparatus 18 further includes the control unit 18c that controls the host vehicle 10 such that the host vehicle 10 travels along a target travel trajectory without operation by a driver of the host vehicle 10. Accordingly, a travel trajectory that can improve the driving comfort can be determined as a target travel trajectory, and automated driving can be performed using such a target travel trajectory. Thus, the driving comfort can be improved.

Preferably, the processing apparatus 18 further includes the control unit 18c that performs notification control for notifying a driver of the host vehicle 10 of a target travel trajectory. Accordingly, a travel trajectory that can improve the driving comfort can be determined as a target travel trajectory, and the driver can be notified of such a target travel trajectory. Thus, the driving comfort can be improved.

Although the preferred embodiment of the invention has been described above with reference to the accompanying drawings, it is obvious that the invention is not limited to the above-described embodiment, and it is also obvious that various changes and modifications within the scope described in the claims also belong to the technical scope of the invention.

For example, in the above, the processing performed by the processing apparatus 18 and the processing performed by the server 20 have been described separately from each other. However, any part of the processing described above as being performed by the processing apparatus 18 may be performed by the server 20, and any part of the processing described above as being performed by the server 20 may be performed by the processing apparatus 18.

Also, for example, the processing described in this specification using a flowchart may not necessarily be performed in the order shown in the flowchart. Some processing steps may be performed in parallel. In addition, additional processing steps may be employed, or some processing steps may be omitted.

In addition, for example, the series of processes performed by the processing apparatus 18 described above may be implemented using any of software, hardware, and a combination of software and hardware. For example, a program constituting the software is stored in advance in a storage medium provided inside or outside an information processing apparatus.

### REFERENCE SIGNS LIST

10: Vehicle (host vehicle)
11: Drive source
12: Brake apparatus
13: Steering mechanism
14: Display apparatus
15: Navigation apparatus
16: Surrounding environment sensor (sensor)
17: Vehicle speed sensor
18: Processing apparatus
18a: Communication unit (acquisition unit)
18b: Determination unit
18c: Control unit
20: Server
20a: Communication unit
20b: Processing unit
20c: Storage unit
30: Uneven portion
41: Travel trajectory
42: Trajectory
51: Travel trajectory
52: Trajectory
61: Travel trajectory
62: Trajectory
L1: Travel lane
L2: Adjacent lane
LB1: Lane boundary
N1: Communication network

1. A processing apparatus (18) for determining a target travel trajectory of a host vehicle (10), the processing apparatus:
configured to acquire trajectory information indicating a standard travel trajectory, the standard travel trajectory being a travel trajectory that is generated based on information on a travel result of a plurality of vehicles and is typical in a traffic lane; and
configured to determine the target travel trajectory based on the trajectory information.

2. The processing apparatus according to claim 1, further configured to determine a travel trajectory (51, 61) that follows the standard travel trajectory as the target travel trajectory.

3. The processing apparatus according to claim 2, further configured to determine the target travel trajectory based on a positional relationship between a lane boundary (LB1), which is a boundary between a travel lane (L1) of the host vehicle (10) and an adjacent lane (L2) adjacent to the travel lane (L1), and the standard travel trajectory.

4. The processing apparatus according to claim 3, further configured to determine the target travel trajectory such that the host vehicle (10) does not go beyond the lane boundary (LB1) when the host vehicle (10) travels along the target travel trajectory.

5. The processing apparatus according to claim 3, further configured to
determine the target travel trajectory based on the positional relationship when a possibility of collision between the host vehicle (10) and another vehicle traveling in the adjacent lane (L2) exceeds a criterion, and
determine the target travel trajectory not based on the positional relationship when the possibility of collision is lower than the criterion.

6. The processing apparatus according to claim 3, further configured to
determine the target travel trajectory based on the positional relationship when it is determined that an obstacle is present at the lane boundary (LB1), and
determine the target travel trajectory not based on the positional relationship when it is determined that no obstacle is present at the lane boundary (LB1).

7. The processing apparatus according to claim 1, wherein the host vehicle (10) is mounted with a sensor (16) configured to detect road surface information, and
further configured to determine the target travel trajectory based on a detection result of the sensor (16) in addition to the trajectory information.

8. The processing apparatus according to claim 1, further comprising a control unit (18c) configured to control the host vehicle (10) such that the host vehicle (10) travels along the target travel trajectory without operation by a driver of the host vehicle (10).

9. The processing apparatus according to claim 1, further comprising a control unit (18c) configured to perform notification control for notifying a driver of the host vehicle (10) of the target travel trajectory.

10. A processing method for determining a target travel trajectory of a host vehicle (10), the method comprising:
acquiring, via a processing apparatus (18), trajectory information indicating a standard travel trajectory being a travel trajectory that is generated based on information on a travel result of a plurality of vehicles and is typical in a traffic lane, and
determining, via the processing apparatus (18), the target travel trajectory based on the trajectory information.
